(19) United States
(12) Patent Application Publication
(10) Pub. No.: US 2009/0246579 A1
(43) Pub. Date: Oct. 1, 2009

(54) FUEL CELL SYSTEM AND FLOW CONTROL MECHANISM THEREOF

(75) Inventors: Chih-Yen LIN, Taoyuan County (TW); Hsin-Chou CHEN, Taoyuan County (TW); Chiang-Wen LAI, Taoyuan County (TW); Yu-Chun KO, Taoyuan County (TW); Yue-Jing DOU, Taoyuan County (TW)

Correspondence Address: QUINTERO LAW OFFICE, PC, 2210 MAIN STREET, SUITE 200, SANTA MONICA, CA, 90405, US

(73) Assignee: NAN YA PCB CORP., Taoyuan County (TW)

(21) Appl. No.: 12/129,626

(22) Filed: May 29, 2008

(30) Foreign Application Priority Data
Mar. 25, 2008 (TW) TW97110508

(51) Int. Cl. H01M 8/04

(52) U.S. Cl. 429/22; 429/34; 137/565.11; 137/861

(57) ABSTRACT

A fuel cell system and a flow control mechanism thereof are provided. The fuel cell system includes a plurality of fuel cells and the flow control mechanism. The flow control mechanism includes a distributing device and a confluence device, and the cells are stacked between the distributing device and the confluence device. The distributing device or the confluence includes at least one inlet, at least one outlet, at least one passage and at least one buffering section. The passage communicates with the inlet and the outlet. The buffering section is disposed in any position of the passage. The buffering section and the inlet are on different levels.

### CROSS REFERENCE TO RELATED APPLICATIONS

This Application claims priority of Taiwan Patent Application No. 97110508, filed on Mar. 25, 2008, the entirety of which is incorporated by reference herein.

### BACKGROUND OF THE INVENTION

1. Field of the Invention

The present invention relates to a fuel cell system and a flow control mechanism thereof, and in particular, to a fuel cell system utilizing the flow control mechanism to uniformly distribute fuel into each fuel cell.

2. Description of the Related Art

Referring to FIG. 1, a conventional fuel cell system comprises a mixing tank 11. The fuel (ex. water and methanol) is mixed in the mixing tank 11, and then it is delivered to the fuel cell through pipes.

As shown in FIG. 1, the mixing tank 11 comprises two inlets 111, a plurality of passages 112 and a plurality of outlets 13 communicating with the passages 112, wherein each outlet 113 respectively connects with a fuel cell (not shown) by a pipe (not shown). The inlets 111 respectively allow water and methanol to enter the passages 112. Water and methanol are mixed in the passages 112 to become fuel. The fuel then exits through the outlets 113, and is carried to the fuel cells by the pipes.

It should be noted that the inlets 111, the passages 112 and the outlets 113 of the mixing tank 11 are all on the same level, such that the mixing tank 11 must be positioned horizontally to avoid non-uniform distribution of fuel into the fuel cells. Additionally, when many fuel cells are stacked to form a fuel cell unit, connecting pipes to the fuel cells is not easy, increasing mass production difficulties and leakage possibilities.

### BRIEF SUMMARY OF THE INVENTION

Accordingly, the invention provides a fuel cell system and a flow control mechanism thereof. The fuel cell system comprises a plurality of fuel cells and the flow control mechanism. The flow control mechanism comprises a distributing device and a confluence device, and the cells are stacked between the distributing device and the confluence device. The distributing device or the confluence comprises at least one inlet, at least one outlet, at least one passage and at least one buffering section. The passage communicates with the inlet and the outlet. The buffering section is disposed in any position of the passage. The buffering section and the inlet are on different levels.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional mixing tank;

FIG. 2 is a schematic view of a fuel cell system of the invention;

FIG. 3 is a schematic view of a distributing device of the invention;

FIG. 4 is a top view of the distributing device of the invention;

FIG. 5 is a side view showing distribution through passages of the invention; and

FIG. 6 is a schematic view of a variant embodiment of the fuel cell system of the invention.

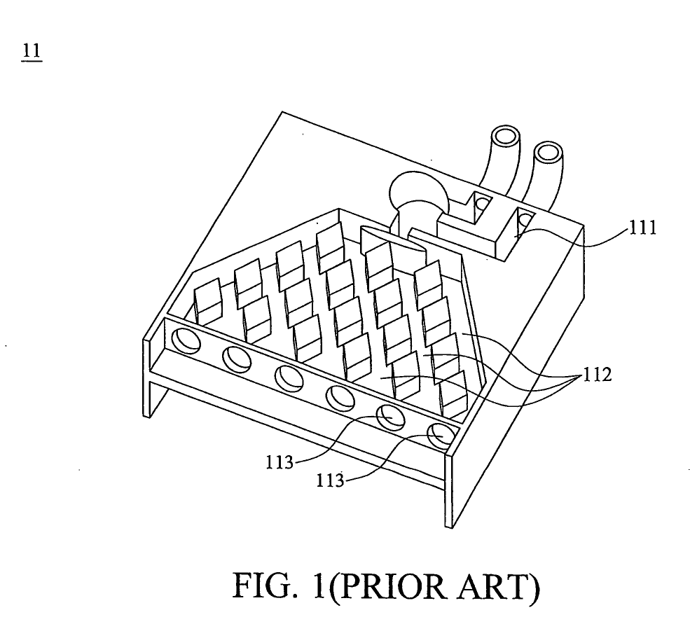

### DETAILED DESCRIPTION OF THE INVENTION

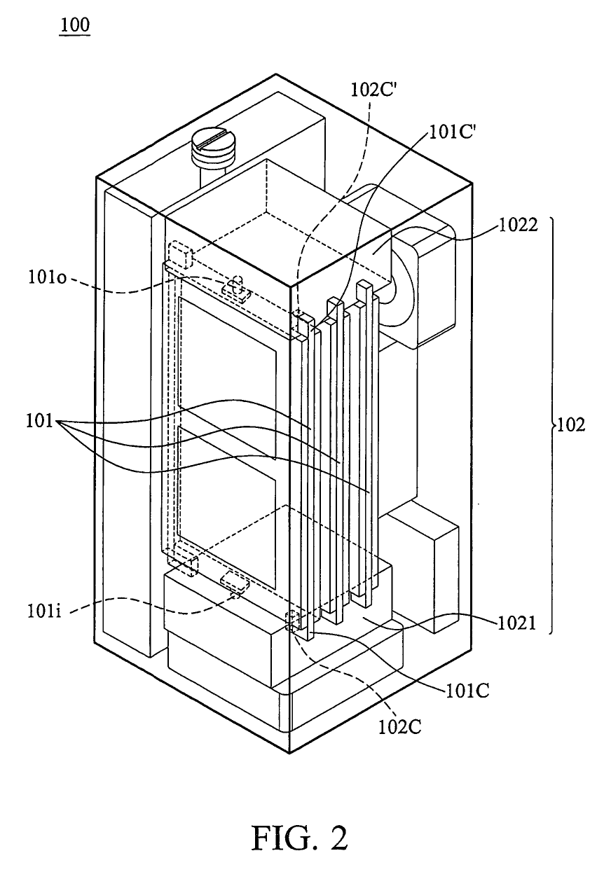

FIG. 2 depicts a schematic view of a fuel cell system 100 of the invention. The fuel cell system 100 comprises three fuel cells 101 and a flow control mechanism 102. The flow control mechanism 102 comprises a distributing device 1021 and a confluence device 1022. Three fuel cells 101, stacked and disposed between the distributing device 1021 and confluence device 1022, are communicated with the distributing device 1021 and the confluence device 1022. It should be noted that the amount of the fuel cells 101 are decided according to demand. In this embodiment, the number of the fuel cells 101 is three, but it is not limited thereto.

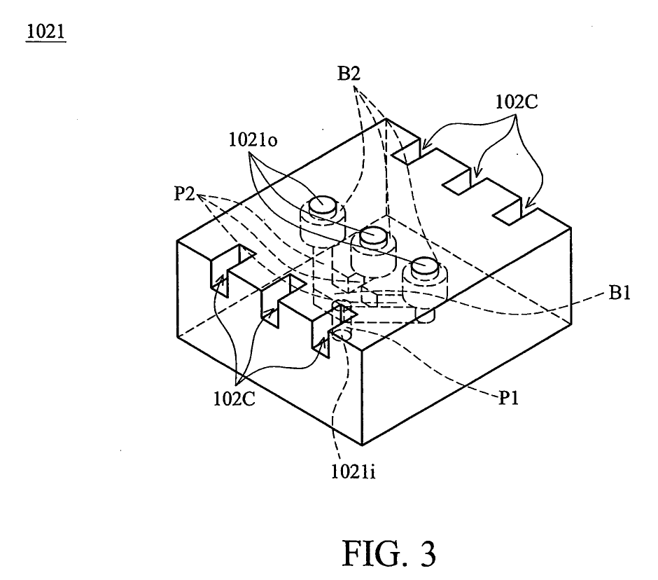

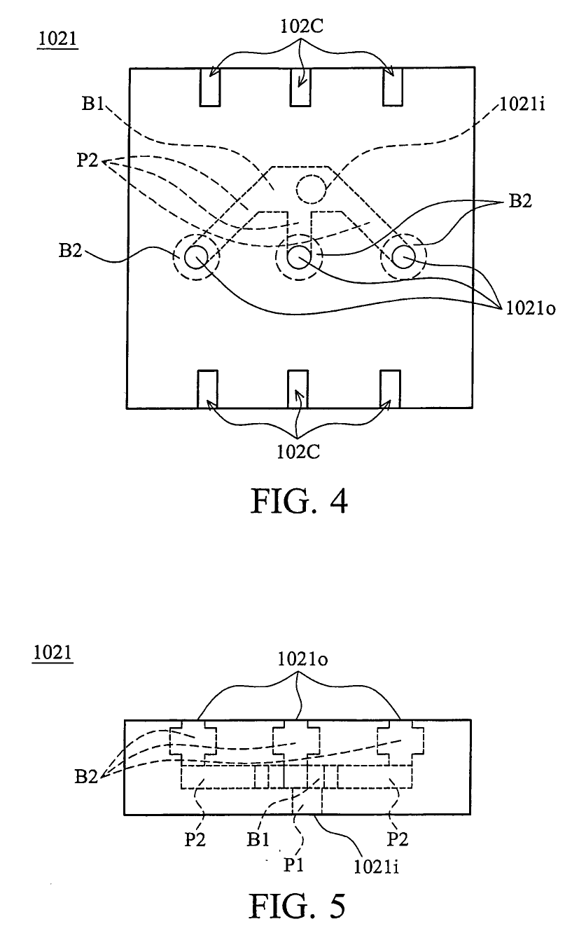

FIG. 3 depicts a schematic view of the distributing device of the invention; FIG. 4 depicts a top view of the distributing device of the invention; FIG. 5 depicts a side view showing distribution through passages of the invention. The distributing device 1021 has an inlet 1021i, an outlet 1021o, a first passage P1, three second passages P2, a first buffering section B1 and three second buffering sections B2. The distributing device 1021 communicates with the fuel cells 101 by connecting the outlet 1021o with the fuel inlets 101i of the fuel cells 101 (as shown in FIG. 2). The first passage P1, communicated with the inlet 1021i, is bent to form the first buffering section B1 on a different horizontal level. One end of each of the three second passages P2 communicates with the first buffering section B1, and the other end of each of the three second passages P2 is bent to form the second buffering section B2 and communicates with the outlet 1021o. Besides, the second buffering sections B2, the inlet 1021i and the first buffering section B1 are all on different level.

Because the first buffering section B1 and the inlet 1021i are formed on different levels, the fuel, entering the distributing device 1021 through the first passage P1, directly flows into the first buffering section B1 on a different level with the inlet 1021i. The fuel is buffered in the first buffering section B1, and then enters the second passages P2 simultaneously, allowing every fuel cell to receive even amounts of fuel.

The second buffering sections B2 and the first buffering section B1 are formed on different levels, and the diameter of each second buffering section B2 is greater than that of each second passage P2. As a result, before entering the fuel cells, the fuel is accumulated in the second buffering sections B2 adjacent to the outlets 1021o, further increasing the flow rate of the fuel entering the fuel cells 101.

In the embodiment, the distributing device 1021 and the confluence device 1022 comprises the same structure, thus detailed description of the structure of the confluence device 1022 is omitted. The only difference between the distributing device 1021 and the confluence device 1022 is that the disposition of inlet and the outlet of the distributing device 1021 is opposite to the disposition of the inlet and the outlet of the confluence device 1022 in order to symmetrically arrange the distributing device 1021 and the confluence device 1022 on different ends of the fuel cells 101. In other words, the same structure of the distributing device 1021 is placed upside down, such that the inlets of the confluence device 1022 communicate with fuel outlets 101o of the fuel cells (as shown in FIG. 2), and the outlet of the confluence device 1022 allows exiting of the fuel. Except for opposite disposition of the inlet and the outlet of the distributing device 1021 and the confluence device 1022, they both comprise the same structure, but it is not limited thereto. The number of passages and buffering sections can be designed upon different requirements, and the buffering sections can be disposed on any position of the passage.

By communicating the fuel inlets 101i of the fuel cells 101 with the outlets 1021o of the distributing device 1021, and the fuel outlets of the fuel cells 101 with the inlets of the confluence device 1022, the fuel, from a tank (not shown), is able to flow to the distributing device 1021, distributing uniformly into every fuel cell 101. Reactant (ex. Water and carbon dioxide) produced within the fuel cells flows to the confluence device 1022 to be collected and recycled into the tank.

Referring to FIGS. 2 and 3, each fuel cell 101 comprises two first connecting portions 101C on two sides of the fuel inlet 101i, respectively, and two second connecting portions 101C′ on two sides of the fuel outlet 101o, respectively. The distributing device 1021 comprises three pairs of the first corresponding connecting portion 102C, and the confluence device 1022 comprises three pairs of the second corresponding connecting portion 102C′. A constant distant is kept between every first corresponding connecting portion 102C, and a constant distant is kept between every second corresponding connecting portion 102C′. Two of the first connecting portion 101C of each fuel cell 101 engage with a pair of the first corresponding connecting portion 102C, allowing an end of the fuel cell 101 to connect with the distributing device 1021. Two of the second connecting portion 101C′ of each fuel cell 101 engage with a pair of the second corresponding connecting portion 102C′, allowing the other end of the fuel cell 101 to connect with the confluence device 1022. Accordingly, the fuel cells 101 are firmly fixed between the distributing device 1021 and the confluence device 1022, and every fuel cell 101 is kept at a constant distance between each other.

As shown in FIG. 2, the first connecting portion 101C and the second connecting portion 101C′ are formed to be protrusions, and the first corresponding connecting portion 102C and the second corresponding connecting portion 102C′ are formed to be recesses, but it is not limited thereto. The connecting portion and the corresponding connecting portion can be formed in any shape, as along as they can fix the fuel cells 101 between the distributing device 1021 and the confluence device 1022.

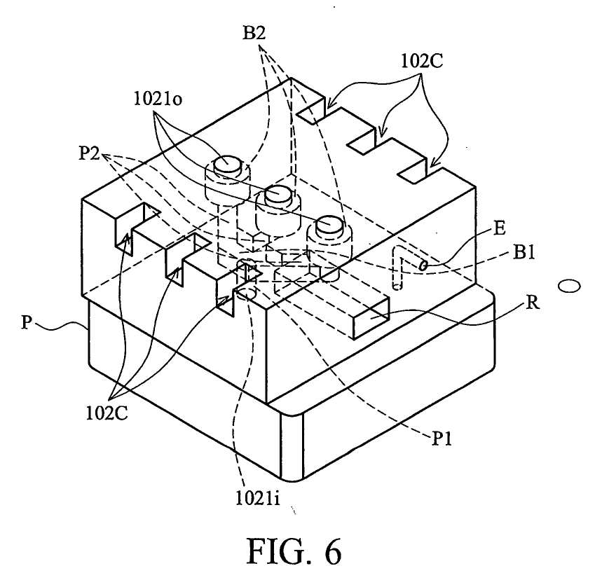

FIG. 6 depicts a schematic view of a variant embodiment of the fuel cell system of the invention. In this variant embodiment, the fuel cell system further comprises a pump P, and the distributing device 1021 further comprises an accommodating portion. The pump P communicates with the distributing device 1021. The fuel enters the distributing device 1021 through a feeding aperture E, and into the pump P. The fuel is then pumped by the pump P into the distributing device 1021 again. The accommodating portion R receives an electronic device for monitoring the fuel status within the fuel cell system, such as a thermometer, a flow meter, a concentration meter etc. When a flow meter or a concentration meter is placed in the accommodating portion R, the fuel is pressurized by the pump P to pass by the accommodating portion R, and then flows into the first buffering section B1. At the time the fuel passes by the accommodating portion R, the flow meter or the concentration meter disposed therein calculates the flow rate or the concentration of the fuel.

The flow control mechanism 102 of the fuel cell system 100 of the invention utilizes a buffering zone to control the flow rate of the fuel. After the fuel enters the distributing device 1021, the amount of fuel is uniformly distributed into every fuel cell 101. Moreover, because the buffering sections B1, B2 are on different levels with the inlet 1021i, the flow control mechanism 102 can be tilted or placed horizontally, avoiding uneven distribution of the fuel. In addition, the fuel cells 101 directly engage with the flow control mechanism 102 without pipe connection, thus reducing fuel leakage possibilities and increasing efficiency and convenience of assembly.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell system, comprising
a plurality of fuel cells;
a flow control mechanism comprising a distributing device and a confluence device, and the cells being stacked between the distributing device and the confluence device, wherein the distributing device or the confluence comprises:
at least one inlet;
at least one outlet;
at least one passage communicating with the inlet and the outlet; and
at least one buffering section disposed in any position of the passage, wherein the buffering section and the inlet are on different levels.

2. The fuel cell system as claimed in claim 1, wherein the distributing device comprises one inlet, a plurality of passages and a plurality of outlets, and the fuel cells communicate with the outlets, respectively.

3. The fuel cell system as claimed in claim 1, wherein the confluence device comprises a plurality of inlets, a plurality of passages and one outlet, and the fuel cells communicate with the inlets, respectively.

4. The fuel cell system as claimed in claim 1, wherein the buffering section is adjacent to the inlet or the outlet.

5. The fuel cell system as claimed in claim 1, wherein the distributing device or the confluence device comprises a plurality of buffering sections adjacent to the inlet and the outlet, respectively.

6. The fuel cell system as claimed in claim 5, wherein the buffering sections are located on different levels.

7. The fuel cell system as claimed in claim 1, wherein the buffering section is formed by bending the passage.

8. The fuel cell system as claimed in claim 1, further comprising a pump communicating with the distributing device.

9. The fuel cell system as claimed in claim 1, wherein each of the fuel cells comprises a first connecting portion, and the confluence device comprises at least one first corresponding connecting portion connected to the first connecting portion.

10. The fuel cell system as claimed in claim 9, wherein each of the fuel cells comprises a second connecting portion, and the confluence device comprises at least one second corresponding connecting portion connected to the second connecting portion.

11. A flow control mechanism for communicating with a plurality of fuel cells, comprising
a distributing device and a confluence device, the distributing device or the confluence comprising:
at least one inlet;
at least one outlet;
at least one passage communicating with the inlet and the outlet; and
at least one buffering section disposed in any position of the passage, wherein the buffering section and the inlet are on different levels.

12. The flow control mechanism as claimed in claim 11, wherein the distributing device comprises one inlet, a plurality of passages and a plurality of outlets, and the fuel cells communicate with the outlets, respectively.

13. The flow control mechanism as claimed in claim 11, wherein the confluence device comprises a plurality of inlets, a plurality of passages and one outlet, and the fuel cells communicate with the inlets, respectively.

14. The flow control mechanism as claimed in claim 11, wherein the buffering section is adjacent to the inlet or the outlet.

15. The flow control mechanism as claimed in claim 11, wherein the distributing device or the confluence device comprises a plurality of buffering sections adjacent to the inlet and the outlet, respectively.

16. The flow control mechanism as claimed in claim 15, wherein the buffering sections are located on different levels.

17. The flow control mechanism as claimed in claim 11, wherein the buffering section is formed by bending the passage.

18. The flow control mechanism as claimed in claim 11, further comprising a pump communicating with the distributing device.

19. The flow control mechanism as claimed in claim 11, wherein each of the fuel cells comprises a first connecting portion, and the confluence device comprises at least one first corresponding connecting portion connected to the first connecting portion.

20. The flow control mechanism as claimed in claim 19, wherein each of the fuel cells comprises a second connecting portion, and the confluence device comprises at least one second corresponding connecting portion connected to the second connecting portion.
